(19) United States
(12) Patent Application Publication
(10) Pub. No.: US 2023/0238836 A1
(43) Pub. Date: Jul. 27, 2023

(54) APPARATUS AND METHOD FOR TRANSMITTING POWER WIRELESSLY

(71) Applicant: HITACHI-LG DATA STORAGE KOREA, INC., Seoul (KR)

(72) Inventor: Cheol JIN, Seoul (KR)

(73) Assignee: HITACHI-LG DATA STORAGE KOREA, INC., Seoul (KR)

(21) Appl. No.: 18/093,441

(22) Filed: Jan. 5, 2023

(30) Foreign Application Priority Data
Jan. 24, 2022 (KR) 10-2022-0009798

(51) Int. Cl. H02J 50/80; H02J 50/12

(52) U.S. Cl. CPC H02J 50/80; H02J 50/12

(57) ABSTRACT

The method for transmitting power wirelessly may comprise: transmitting power wirelessly to a receiving device, receiving, from the receiving device, a first Q factor including a Q frequency and a Q value measured by the receiving device while transmitting the power, and obtaining a second foreign object boundary line by adjusting a first foreign object boundary line based on a first Q point corresponding to the first Q factor in a Q plane with a Q frequency and a Q value as two axes. The method may detect, as a second Q factor, a Q frequency and a Q value of a resonance circuit included in a transmitting apparatus, and continue or stop a power transmitting operation based on a comparison of a second Q point corresponding to the second Q factor and the second foreign object boundary line in the Q plane.

This application claims the benefit of priority under 35 U.S.C. § 119(a) to Korean Patent Application No. 10-2022-0009798 filed on Jan. 24, 2022, which is incorporated by reference herein in its entirety.

### BACKGROUND

### Field

This disclosure relates to an apparatus and method for transmitting power wirelessly, and more particularly, to a method for effectively detecting a foreign object attached to a receiving device.

### Related Art

With the development of communication and information processing technology, use of smart terminals such as a smart phone and the like has gradually increased and at present, a charging scheme generally applied to the smart terminals is a scheme that directly connects an adapter connected to a power supply to the smart terminal to charge the smart phone by receiving external power or connects the adapter to the smart terminal through a USB terminal of a host to charge the smart terminal by receiving USB power.

In recent years, in order to reduce inconvenience that the smart terminal needs to be directly connected to the adapter or the host through a connection line, a wireless charging scheme that wirelessly charges a battery by using magnetic coupling without an electrical contact has been gradually applied to the smart terminal.

There are several methods for wirelessly supplying or receiving electrical energy, representatively, an inductive coupling method based on electromagnetic induction and a resonance coupling method (that is electromagnetic resonance coupling method) based on an electromagnetic resonance phenomenon using a wireless power signal of a specific frequency.

In both methods, it is possible to secure stability of power transmission and increase transmission efficiency by exchanging data through the communication channel formed between a wireless charging apparatus and an electronic device such as a smart terminal. The inductive coupling method has a problem in that the transmission efficiency is lowered by the movement of the power receiving device while wirelessly receiving power, and the resonant coupling method has a problem in that power transmission is interrupted due to noise occurring in the communication channel.

When there is a metal foreign object such as a coin between a transmitting apparatus and a receiving device, power loss occurs and if the wireless transmission power is concentrated on the metal foreign object, there is a risk of overheating, which hinders stable power transmission. Therefore, a foreign object detection (FOD) function capable of detecting whether or not a metal foreign object is placed in a transmission apparatus is necessarily implemented in a product to which a wireless charging standard of the inductive coupling method is applied.

A technique for determining whether the difference between transmission power and reception power is greater than or equal to a predetermined value by detecting the difference, or a technique for comparing a Q value transmitted from a receiving device with a Q value of a transmission coil measured while transmitting power is being used to detect the metal foreign object.

However, there is a problem that the latter case is not applicable to the receiving device that does not transmit a Q value. In addition, if the size of a metal material such as a clip is small or if there is a foreign object in the case of a power receiving device, for example a smart phone, there are cases where the wireless charger cannot detect it, and in these cases the charging efficiency may decrease and heat may be generated.

The latest standard (Qi 1.3) contains the content that a receiving device transmits not only a Q value but also a Q frequency to a transmitting apparatus, and receiving devices satisfying this standard are being released. However, a method for efficiently detecting a foreign object using a Q frequency provided by a receiving device has not yet been proposed.

### SUMMARY

This disclosure has been made in view of this situation, and an object of this disclosure is to provide a method for a transmitting apparatus to effectively determine whether there is a foreign material attached to a receiving device.

Another object of this disclosure is to provide a method for effectively determining whether a foreign object is present using a Q frequency transmitted from a receiving device.

The method for transmitting power wirelessly according to an embodiment of this disclosure may comprise transmitting power wirelessly to a receiving device, receiving, from the receiving device, a first Q factor including a Q frequency and a Q value measured by the receiving device while transmitting the power, and obtaining a second foreign object boundary line by adjusting a first foreign object boundary line based on a first Q point corresponding to the first Q factor in a Q plane with a Q frequency and a Q value as two axes.

The wireless power transmitting apparatus according to another embodiment of this disclosure may comprise a power conversion unit including an inverter for converting a DC power into an AC power and a resonance circuit including a primary coil for transmitting power by magnetic induction coupling with a secondary coil of a receiving device, a Q factor detection unit configured to detect a Q frequency and a Q value of the resonance circuit as a Q factor while transmitting the power, a communication unit configured to receive, from the receiving device, a first Q factor including a Q frequency and a Q value measured by the receiving device, and a control unit configured to control the power conversion unit to transmit the power to the receiving device and obtain a second foreign object boundary line by adjusting a first foreign object boundary line based on a first Q point corresponding to the first Q factor received through the communication unit in a Q plane with a Q frequency and a Q value as two axes.

Therefore, it is possible to effectively determine whether or not a metal foreign object is on a transmitting apparatus or between a transmitting apparatus and a receiving device, and it is possible to prevent in advance the risk of excessive heat generation and fire due to the concentration of output on the metal foreign object during wireless power transmission.

### BRIEF DESCRIPTION OF THE DRAWINGS

FIG. 1 conceptually illustrates that power is wirelessly transmitted from a power transmitting apparatus to an electronic device,

FIG. 2 conceptually illustrates a circuit configuration of a power conversion unit of a transmitting module for wirelessly transmitting power in an electromagnetic induction scheme,

FIG. 3 illustrates a configuration for a wireless power transmitting module and a wireless power receiving module to send and receive power and messages,

FIG. 4 is a block diagram of a loop for controlling power transmission between a wireless power transmitting module and a wireless power receiving module,

FIG. 5 shows a circuit for detecting a Q factor including a Q value and a Q frequency using a ratio of an input voltage to an output voltage and a graph of a detected Q factor,

FIG. 6 illustrates the concept of determining whether a foreign object is present by detecting signal attenuation,

FIG. 7 shows an example of setting an FOD line, which distinguishes a case where there is a foreign object from a case where a charge is possible based on the Q value and Q frequency measured while changing the location of a receiving device and the type and location of a foreign object, on a Q plane having a Q value and a Q frequency as two axes,

FIGS. 8A to 8C show examples in which the FOD line in the Q plane cannot clearly distinguish between a case in which a foreign object is present and a case in which charging is possible,

FIG. 9 shows an example of calculating the distance between the FOD line and the coordinates determined by the Q value and Q frequency transmitted from a receiving device in the Q plane,

FIGS. 10A to 10C show examples in which the FOD line clearly distinguishes between a case in which a foreign object is present and a case in which charging is possible by adding an offset to the FOD line with a Q value and a Q frequency transmitted from a receiving device,

FIG. 11 shows the configuration of a wireless power transmission apparatus to which the embodiment of this disclosure is applied in blocks,

FIG. 12 is a flowchart illustrating an operation of a method for wirelessly transmitting power while detecting a foreign object according to an embodiment of this disclosure.

### DETAILED DESCRIPTION

Hereinafter, an embodiment of an apparatus and method for transmitting power wirelessly according to this disclosure will be described in detail with reference to the accompanying drawings.

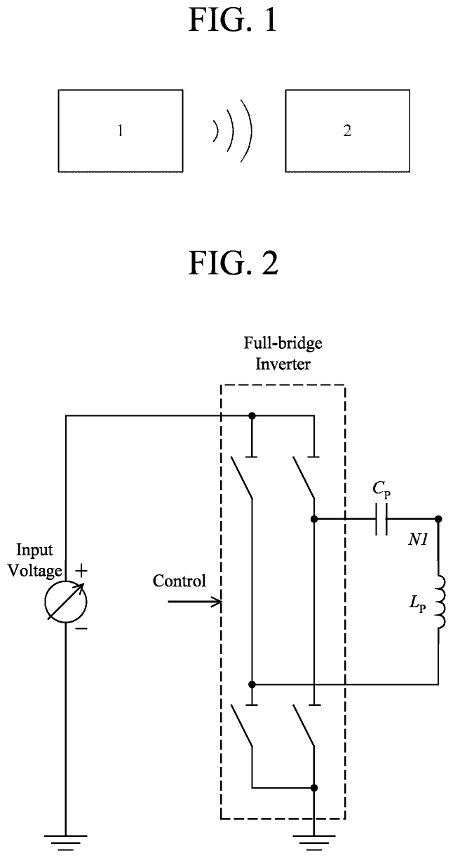

FIG. 1 conceptually illustrates that power is wirelessly transmitted from a wireless power transmitting apparatus to an electronic device.

The wireless power transmitting apparatus 1 may be a power transferring apparatus wirelessly transferring power required by a wireless power receiving apparatus or an electronic device 2, or a wireless charging apparatus for charging a battery by wirelessly transferring power. Or the wireless power transmitting apparatus 1 may be implemented by one of various types of apparatuses transferring power to the electronic device 2 requiring power with non-contact.

The electronic device 2 may be operable by wirelessly receiving power from the wireless power transmitting apparatus 1 and charge a battery by using wirelessly received power. The electronic device that wirelessly receives power may include portable electronic devices, for example, a smart phone, a tablet computer, a multimedia terminal, an input/output device such as a keyboard, a mouse, a video or audio auxiliary device, a secondary battery, and the like.

Power may be wirelessly transmitted by an inductive coupling scheme based on an electromagnetic induction phenomenon by a wireless power signal generated by the wireless power transmitting apparatus 1. That is, resonance is generated in the electronic device 2 by the wireless power signal transmitted by the wireless power transmitting apparatus 1 and power is transferred from the wireless power transmitting apparatus 1 to the electronic device 2 without contact by the resonance. A magnetic field is changed by an AC current in a primary coil and current is induced to a secondary coil by the electromagnetic induction phenomenon to transfer power.

When the intensity of the current that flows on a primary coil of the wireless power transmitting apparatus 1 is changed, the magnetic field passing through the primary coil (or a transmitting Tx coil or a first coil) is changed by the current and the changed magnetic field generates induced electromotive force at a secondary coil (or a receiving Rx coil or a second coil) in the electronic device 2.

When the wireless power transmitting apparatus 1 and the electronic device 2 are disposed such that the transmitting coil at the wireless power transmitting apparatus 1 and the receiving coil at the electronic device 2 come close to each other and the wireless power transmitting apparatus 1 controls the current of the transmitting coil to be changed, the electronic device 2 may supply power to a load such as a battery by using the electromotive force induced to the receiving coil.

Efficiency of the wireless power transmission based on the inductive coupling scheme is influenced by a layout and a distance between the wireless power transmitting apparatus 1 and the electronic device 2. The wireless power transmitting apparatus 1 is configured to include a flat interface surface and a transmitting coil is mounted on the bottom of the interface surface and one or more electronic devices may be laid on the top of the interface surface. By making the gap between the transmitting coil mounted on the bottom of the interface surface and the receiving coil positioned on the top of the interface surface sufficiently small, the efficiency of the wireless power transmission by the inductive coupling method can be increased.

A mark indicating a location where the electronic device is to be laid may be displayed on the top of the interface surface of the wireless power transmitting apparatus. The mark may indicate the position of the electronic device which makes the arrangement between the primary coil mounted on the bottom of the interface surface and the secondary coil suitable. A protruded structure for guiding the location of the electronic device may be formed on the top of the interface surface. And a magnetic body may be formed on the bottom of the interface surface so that the primary coil and the secondary coil can be guided by an attractive force with a magnetic body of the other pole provided inside the electronic device.

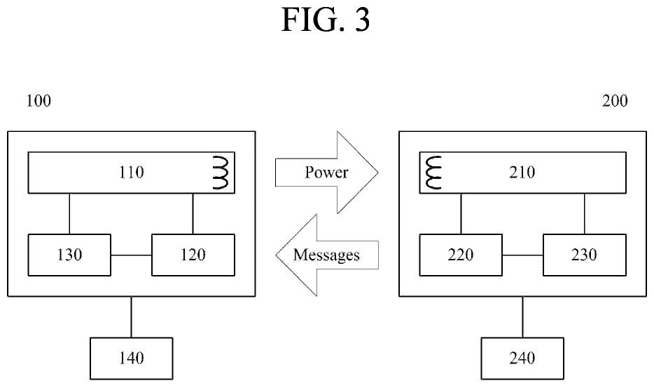

FIG. 2 conceptually illustrates a circuit configuration of a power conversion unit of a transmitting module for wirelessly transmitting power in an electromagnetic induction scheme.

The wireless power transmitting module may include a power conversion unit generally including a power source, an inverter, and a resonance circuit. The power source may be a voltage source or a current source and the power conversion unit converts the power supplied from the power source into a wireless power signal and transfers the converted wireless power signal to a power receiving module. The wireless power signal is formed in the form of the magnetic field or an electronic magnetic field having a resonance characteristic. And, the resonance circuit includes a coil generating the wireless power signal.

The inverter converts a DC input into an AC waveform having a desired voltage and a desired frequency through switching elements and a control circuit. And, in FIG. 2 a full-bridge inverter is illustrated and other types of inverters including a half-bridge inverter, and the like are also available.

The resonance circuit includes a primary coil Lp and a capacitor Cp to transmit power based on a magnetic induction scheme. The coil and the capacitor determine a basic resonance frequency of power transmission. The primary coil forms the magnetic field corresponding to the wireless power signal with a change of current and may be implemented in a flat form or a solenoid form.

The AC current converted by the inverter drives the resonance circuit, and as a result, the magnetic field is formed in the primary coil. By controlling the on/off timings of included switches, the inverter generates AC having a frequency close to the resonance frequency of the resonance circuit to increase transmission efficiency of the transmitting module. The transmission efficiency of the transmitting module may be changed by controlling the inverter.

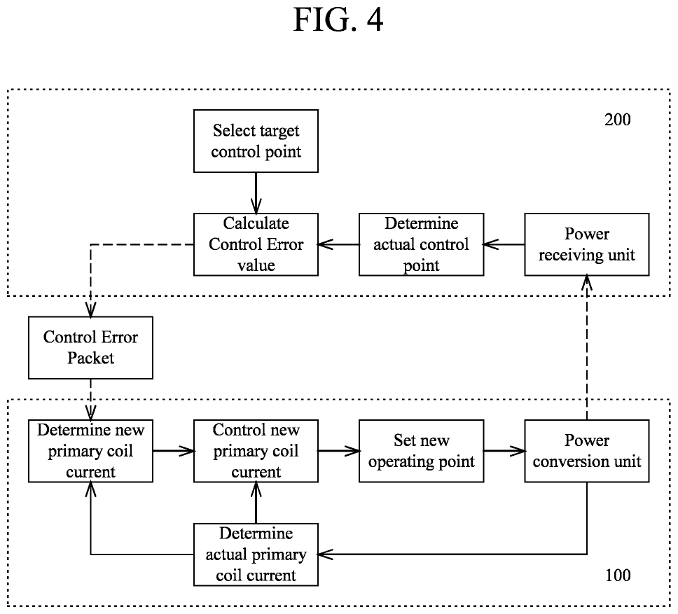

FIG. 3 illustrates a configuration for a wireless power transmitting module and a wireless power receiving module to send and receive power and messages.

Since the power conversion unit just transmits power unilaterally regardless of a receiving state of the receiving module, a configuration for receiving feedback associated with the receiving state from the receiving module is required in the wireless power transmission module in order to transmit power in accordance with the state of the receiving module.

The wireless power transmitting module 100 may include a power conversion unit 110, a communication unit 120, a control unit 130, and a power supply unit 140. And, the wireless power receiving module 200 may include a power receiving unit 210, a communication unit 220, and a control unit 230 and may further include a load 240 (or a power supply unit) to which received power is to be supplied. The load 240 may include a charging unit for charging an internal battery with power supplied from the power receiving unit 210.

The power conversion unit 110 includes the inverter and the resonance circuit of FIG. 2 and may further include a circuit to control characteristics including a frequency, voltage, current, and the like used to form the wireless power signal.

The communication unit 120, connected to the power conversion unit 110, may demodulate the wireless power signal modulated by the receiving module 200 wirelessly receiving power from the transmitting module 100 in the magnetic induction scheme, thereby detecting a power control message.

The control unit 130 determines one or more characteristics among an operating frequency, voltage, and current of the power conversion unit 110 based on the message detected by the communication unit 120 and controls the power conversion unit 110 to generate the wireless power signal suitable for the message. The communication unit 120 and the control unit 130 may be configured as one module.

The power receiving unit 210 may include a matching circuit, including the secondary coil and a capacitor, which generates the inductive electromotive force according to the change of the magnetic field generated from the primary coil of the power conversion unit 110, and may further include a rectification circuit that rectifies the AC current that flows on the secondary coil to output DC current.

The communication unit 220, connected to the power receiving unit 210, may change the wireless power signal between the transmitting module and the receiving module by adjusting the load of the power receiving unit in accordance with a method of adjusting a resistive load at DC and/or a capacitive load at AC to transmit the power control message to the transmitting module.

The control unit 230 of the receiving module controls individual components included in the receiving module. The control unit 230 may measure an output of the power receiving unit 210 in a current or voltage form and control the communication unit 220 based on the measured output to transfer the power control message to the wireless power transmitting module 100. The message may direct the wireless power transmitting module 100 to start or terminate the transmission of the wireless power signal and to control characteristics of the wireless power signal.

The wireless power signal formed by the power conversion unit 110 is received by the power receiving unit 210, and the control unit 230 of the receiving module controls the communication unit 220 to modulate the wireless power signal. The control unit 230 may perform a modulation process to change the amount of power received from the wireless power signal by changing the reactance of the communication unit 220. When the amount of power received from the wireless power signal is changed, a current and/or voltage of the power conversion unit 110 forming the wireless power signal is also changed and the communication unit 120 of the wireless power transmitting module 100 may sense the change in the current and/or voltage of the power conversion unit 110 and perform a demodulation process.

The control unit 230 generates a packet including a message to be transferred to the wireless power transmitting module 100 and modulates the wireless power signal to include the generated packet. The control unit 130 may acquire the power control message by decoding the packet extracted through the communication unit 120. The control unit 230 may transmit a message for requesting a change of the characteristic of the wireless power signal based on the amount of power received through the power receiving unit 210 in order to control to-be-received power.

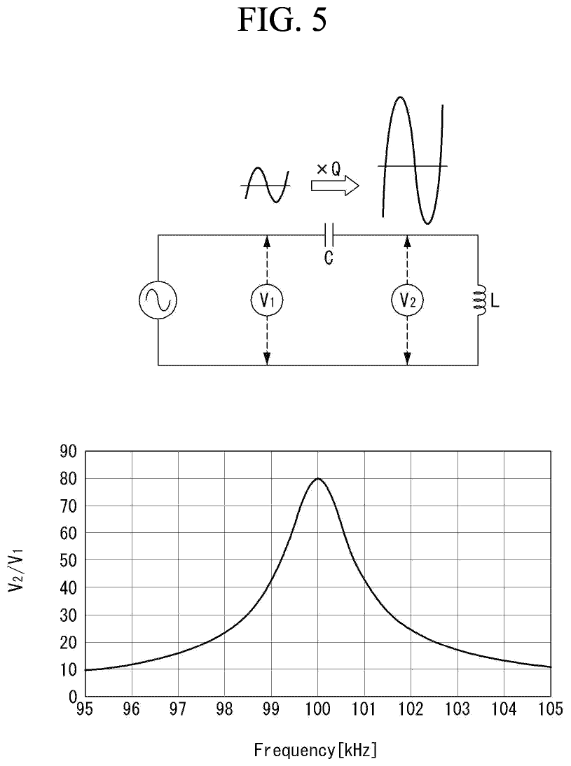

FIG. 4 is a block diagram of a loop for controlling power transmission between a wireless power transmitting module and a wireless power receiving module.

Current is induced in the power receiving unit 210 of the receiving module 200 according to the change of the magnetic field generated by the power conversion unit 110 of the transmitting module 100 and power is transmitted. The control unit 230 of the receiving module selects a desired control point, that is, a desired output current and/or voltage and determines an actual control point of the power received through the power receiving unit 210.

The control unit 230 calculates a control error value by using the desired control point and the actual control point while the power is transmitted and may take the difference between, for example, two output voltages or two output currents as the control error value. When less power is required to reach the desired control point, the control error value may be determined to be, for example, a minus value, and when more power is required to reach the desired control point, the control error value may be determined to be a plus value. The control unit 230 may generate a packet including the calculated control error value calculated by changing the reactance of the power receiving unit 210 with time through the communication unit 220 to transmit the packet to the transmitting module 100.

The communication unit 120 of the transmitting module detects a message by demodulating the packet included in the wireless power signal modulated by the receiving module 200 and may demodulate a control error packet including the control error value.

The control unit 130 of the transmitting module may acquire the control error value by decoding the control error packet extracted through the communication unit 120 and determine a new current value for transmitting power desired by the receiving module by using an actual current value which actually flows on the power conversion unit 110 and the control error value.

When the process of receiving the control error packet from the receiving device is stabilized, the control unit 130 of the transmitting module controls the power conversion unit 110 so that an operating point reaches a new operating point so an actual current value which flows on the primary coil becomes a new current value and a magnitude, a frequency, a duty ratio, or the like of an AC voltage applied to the primary coil becomes a new value. And, the control unit 130 controls the new operating point to be continuously maintained so as for the receiving device to additionally communicate control information or state information.

Interactions between the wireless power transmitting module 100 and the wireless power receiving module 200 may comprise four steps of selection, ping, identification and configuration, and power transfer. The selection step is a step for the transmitting module to discover an object laid on the surface of an interface. The ping step is a step for verifying whether the object includes a receiving module. The identification and configuration step is a preparation step for sending power to the receiving module during which appropriate information is received from the receiving module and a power transfer contract with the receiving module is made based on the received information. The power transfer step is a step of actually transmitting power to the receiving module wirelessly through the interaction between the transmitting module and the receiving module.

In the ping step, the receiving module 200 transmits a signal strength packet SSP indicating a magnetic flux coupling degree between a primary coil and a secondary coil through the modulation of a resonance waveform. The signal strength packet SSP is a message generated by the receiving module based on a rectified voltage. The transmitting module 100 may receive the message from the receiving module 200 and use the message to select an initial driving frequency for power transmission.

In the identification and configuration step, the receiving module 200 transmits to the transmitting module 100 an identification packet including a version, a manufacturer code, apparatus identification information, and the like of the receiving module 200, a configuration packet including information including maximum power, a power transmitting method, and the like of the receiving module 200, and the like.

In the power transmitting step, the receiving module 200 transmits to the transmitting module 100 a control error packet CEP indicating a difference between an operating point where the receiving module 200 receives a power signal and the operating point determined in the power transfer contract, a received power packet RPP indicating an average of the power which the receiving module 200 receives through the surface of the interface, and the like.

The received power packet RPP is the data about the amount of received power, which is obtained by taking a rectified voltage, a load current, an offset power, etc. of the power receiving unit 210 of the receiving device, and continuously transmitted to the transmitting module 100 while the receiving module 200 receives power. The transmitting module 100 receives the reception power packet RPP and uses it as an operation factor for power control.

The communication unit 120 of the transmitting module extracts the packets from change in resonance waveform, and the control unit 130 decodes the extracted packets to acquire the messages and controls the power conversion unit 110 based thereon to wirelessly transmit power while changing power transmission characteristics as the receiving module 200 requests.

Meanwhile, in a scheme that wirelessly transfers power based on inductive coupling, the efficiency is less influenced by frequency characteristics, but influenced by the arrangement and distance between the transmitting module 100 and the receiving module 200.

An area which the wireless power signal can reach may be divided into two. A portion of the interface surface through which a high efficiency magnetic field can pass when the transmitting module 100 wirelessly transmits power to the receiving module 200 may be referred to as an active area. An area where the transmitting module 100 can sense the existence of the receiving module 200 may be referred to as a sensing area.

The control unit 130 of the transmitting module may sense whether the receiving module is disposed in or removed from the active area or the sensing area. The control unit 130 may detect whether the receiving module 200 is disposed in the active area or the sensing area by using the wireless power signal formed in the power conversion unit 110 or using a separately provided sensor.

For example, the control unit 130 may detects whether the receiving module exists by monitoring whether the power characteristics for forming the wireless power signal is changed while the wireless power signal is being affected by the receiving module 200 existing in the sensing area. The control unit 130 may perform a process of identifying the receiving module 200 or determine whether to start wireless power transfer, according to a result of detecting the existence of the receiving module 200.

The power conversion unit 110 of the transmitting module may further include a position determination unit. The position determination unit may move or rotate the primary coil in order to increase the efficiency of the wireless power transfer based on the inductive coupling scheme and in particular, be used when the receiving module 200 does not exist in the active area of the transmitting module 100.

The position determination unit may include a driving unit for moving the primary coil so that a distance between the centers of the primary coil of the transmitting module 100 and the secondary coil of the receiving module 200 is within a predetermined range or so that the centers of the primary coil and the secondary coil overlap with each other. To this end, the transmitting module 100 may further include a sensor or a sensing unit for sensing the position of the receiving module 200. And the control unit 130 of the transmitting module may control the position determination unit based on the positional information of the receiving module 200, which is received from the sensor of the sensing unit.

Alternatively, the control unit 130 of the transmitting module may receive control information regarding the arrangement with or distance from the receiving module 200 through the communication unit 120 and control the position determination unit based on the control information.

Further, the transmitting apparatus 100 may include two or more primary coils to increase transmission efficiency by selectively using some primary coils arranged appropriately with the secondary coil of the receiving module 200 among the two or more primary coils. In this case, the position determination unit may determine which primary coils of the two or more primary coils are used for power transmission.

A single primary coil or a combination of one or more primary coils forming the magnetic field passing through the active area may be designated as a primary cell. The control unit 130 of the transmitting module may sense the position of the receiving module 200, determine the active area based on the determined active area, connect the transmitting module configuring the primary cell corresponding to the active area and control the primary coils of the transmitting module to be inductively coupled to the secondary coil of the receiving module 200.

Meanwhile, since the receiving module 200 is embedded in a smart terminal or an electronic apparatus such as a multimedia reproduction terminal or a smart phone and is laid in a direction or a location which is not constant in a vertical or horizontal direction on the surface of the interface of the transmitting module 100, the transmitting module requires a wide active area.

In case that a plurality of the primary coils are used in order to widen the active area, since a number of drive circuits equal to the number of the primary coils are required and the control over a plurality of primary coils is complicated, the cost of the transmitting module, that is, the wireless charger, is increased during commercialization. Further, in order to expand the active area, even when a scheme of changing the location of the primary coil is applied, since it is necessary to provide a transport mechanism for moving the location of the primary coil, there is a problem that a volume and a weight increase and manufacturing cost increases.

A method that extends the active area even with one primary coil of which the location is fixed is effective. However, when the size of the primary coil is just increased, a magnetic flux density per area decreases and magnetic coupling force between the primary coil and the secondary coil is weakened. As a result, the active area is not so increased as expected and the transmission efficiency is also lowered.

As such, it is important to determine an appropriate shape and an appropriate size of the primary coil in order to extend the active area and improve the transmission efficiency. A multi-coil scheme adopting two or more primary coils may be an effective method that extends the active area of the wireless power transmitting module.

Meanwhile, one of the methods for detecting whether or not a foreign object, particularly a metal foreign object, is placed between the receiving device and the transmitting apparatus is to determine whether the Q factor, that is the Q value and the Q frequency, which is a value related to the resonance of the transmitting apparatus or the receiving device, is changed. If a stored Q factor and a newly detected Q factor are different, it can be determined that there is a foreign object.

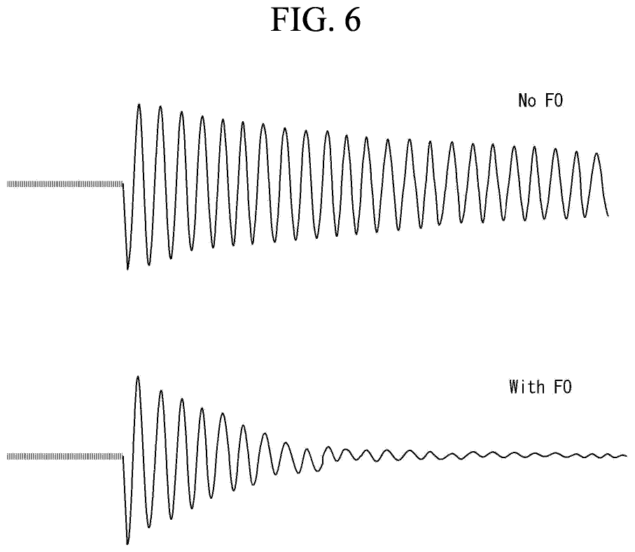

FIG. 5 shows a circuit for detecting a Q factor including a Q value and a Q frequency using a ratio of an input voltage to an output voltage and a graph of a detected Q factor.

The voltage across the coil L may be detected as an output voltage V2 by inputting an AC voltage as an input voltage V1 to the resonant circuit including the capacitor C and the coil L while changing the frequency of the input voltage, and the Q factor related to resonance characteristics may be calculated based on the ratio of the output voltage V2 and the input voltage V1. In the right graph of FIG. 5, it can be seen that a frequency of 100 kHz becomes a resonant frequency and the highest output voltage occurs at the resonant frequency.

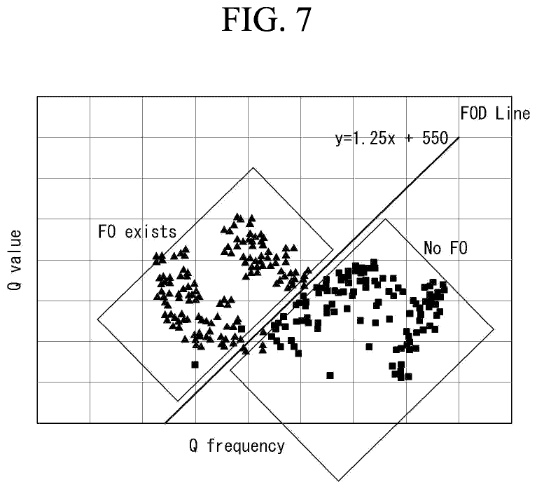

FIG. 6 illustrates the concept of determining whether a foreign object is present by detecting signal attenuation. When the input voltage of a resonance frequency or a frequency close to the resonance frequency is supplied to the resonance circuit, the output signal of the resonance circuit is expressed as

$$v ( t ) = v ( 0 ) \cdot exp ( \frac{w \cdot t}{2 \cdot Q} ) , where w = \frac{2 π}{T} and Q = \frac{π \cdot ( {t}_{3} - {t}_{1} )}{T \cdot ln ( \frac{V ( {t}_{2} )}{V ( {t}_{1} )} )} .$$

If there is no foreign object near the resonant circuit (NO FO), the output signal gradually decreases due to a slight natural attenuation caused by the resistance component constituting the resonant circuit as time goes on. But if there is a foreign object near the resonant circuit (With FO), the output signal is rapidly attenuated due to the interaction between the foreign object and the resonant circuit.

In this way, by detecting the degree of attenuation of the output signal when the resonant circuit is driven at a frequency near the resonant frequency, it may be determined whether a foreign object is nearby.

Although the wireless charger may be provided with a means for determining whether or not a foreign object is in proximity, as shown in FIG. 5 or 6, it is not easy to accurately determine whether a foreign object is present between the wireless charger and a receiver since the wireless charger does not know the Q factor or resonant frequency of the receiver.

Recently, many smart phones capable of wireless charging have been released, and many users cover them in a dedicated case to protect the device and also place it on a wireless charger. A credit card containing an RF module with an RF function such as NFC may be stored inside the case. The RF module of the credit card acts as a foreign object that interferes with the wireless charging operation.

Rather than the case where the receiving device is placed on the interface surface of the wireless charger with a foreign object such as a coin or clip placed on the wireless charger and the foreign object interferes with charging, the case happens more often where the receiving device is placed on top of the wireless charger while a credit card or clip is inserted inside the case of the receiving device and the foreign object interferes with charging.

According to an embodiment of this disclosure, a criterion related to a Q factor capable of distinguishing a state in which a foreign object is present and a state in which charging is possible may be prepared and stored, and it may be determined whether a current charging state is a state in which foreign objects are present or a state in which charging is possible by measuring the Q factor, including a resonant frequency (or Q frequency) and Q value, when charging the receiving device and comparing it to the stored criterion.

More specifically, when wireless power transmission apparatuses are released, a plurality of first Q factors (combinations of a Q value and a Q frequency) are obtained in various situations with foreign objects (for example while moving a metal foreign object at a predetermined interval), a plurality of first Q factors (combinations of a Q value and a Q frequency) are obtained in various situations in which there is no foreign object and charging is possible (for example while moving a receiving device at a predetermined interval), a criterion for distinguishing the first Q factors and the second Q factors from each other may be obtained and stored. When transmitting power wirelessly to a receiving device, the wireless power transmission apparatus storing the criterion may obtain a Q factor and compare it with the stored criterion to determine whether a foreign object is present or whether charging is possible.

Q factors are obtained in various situations where there is a foreign object or charging is possible, the obtained Q factors are located on a plane with the Q frequency and Q value constituting the Q factor as X and Y axes (or Y and X axes), the line dividing the coordinates of the situation where there is a foreign object and the coordinates of the situation where charging is possible is determined, and the line may be used as a criterion for distinguishing between a foreign object situation and a chargeable situation.

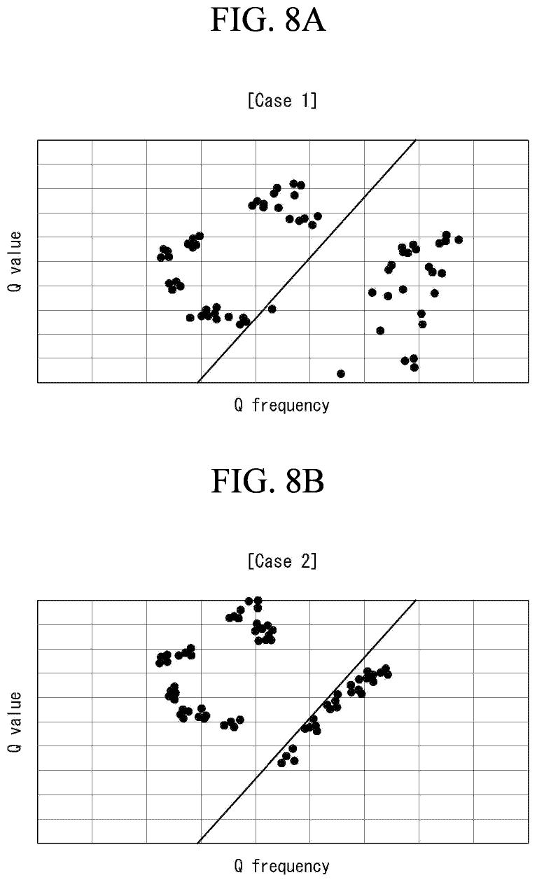

FIG. 7 shows an example of setting an FOD line which distinguishes a case where there is a foreign object from a case where a charge is possible based on the Q value and Q frequency measured while changing the location of a receiving device and the type and location of a foreign object.

A wireless power transmittance apparatus or wireless charger measures a Q factor, that is a Q frequency which is a resonant frequency and a Q value at the resonant frequency, before charging a receiving device.

Afterwards, the wireless charger simulates various situations and measures the Q factor each time. That is, the wireless charger may measure the Q factor while attaching various types of metal foreign objects, such as various sizes of coins, clips, and RF modules such as NFC, to a wireless power receiving device such as a smartphone and charging the smartphone. That is, the Q factors are measured while sequentially moving the metal foreign object on a plane by predetermined length intervals from the center of the smart phone and the wireless charger in the state where the foreign object is attached, and also the Q factors are measured while moving the smart phone with no foreign object.

The Q factors measured in various situations are displayed as coordinates on the Q plane in which a horizontal axis (X axis) is the Q frequency and a vertical axis (Y axis) is the Q value. As shown in FIG. 7, a line capable of distinguishing between a state in which a foreign object is present and a state in which charging is possible without a foreign object may be extracted based on the Q factors stamped on the Q plane.

As shown in FIG. 7, the first area formed in the direction in which the Q frequency is lowered and the Q value is increased may correspond to the situation in which a foreign object is present, and the second area formed in the direction in which the Q frequency is increased and the Q value is decreased may correspond to the situation where there is no foreign object and charging is possible.

It is possible to determine a foreign object boundary line dividing the first area with a foreign object and the second area where charging is possible with no foreign object in a plane (which can be simply referred to as a Q plane) with two axes (one is a Q value axis and the other is a Q frequency axis) perpendicular to each other. It may be expressed as a straight line (FOD line) as shown in FIG. 7, or may be expressed as a quadratic curve or a higher dimensional curve as needed. Hereinafter, the foreign object boundary line is expressed as an FOD line.

When detecting a receiving device and starting wireless charging, the wireless charger measures a Q factor for the detected receiving device, compares the measured Q factor and the FOD line to determine whether the coordinate of the Q factor is in a first area with a foreign object or in a second area without foreign object, stops charging or notifies a user when the coordinate of the Q factor is in the first area, and immediately starts or continues charging when the coordinate of the Q factor is in the second area.

The FOD line (or foreign object boundary curve) may be measured in the process of shipping the corresponding wireless charger and stored in the non-volatile memory of the wireless charger. However, it is not desirable in terms of cost or time to measure and store the FOD line at the time of shipment for all wireless chargers.

Therefore, it is advantageous to measure the FOD lines for a plurality of the same product, obtain one FOD line by averaging the measured FOD lines, and store the averaged FOD line in a non-volatile memory when each product is shipped.

However, since there is variation for each product, the FOD line stored in the memory may not accurately reflect the characteristics of the corresponding product.

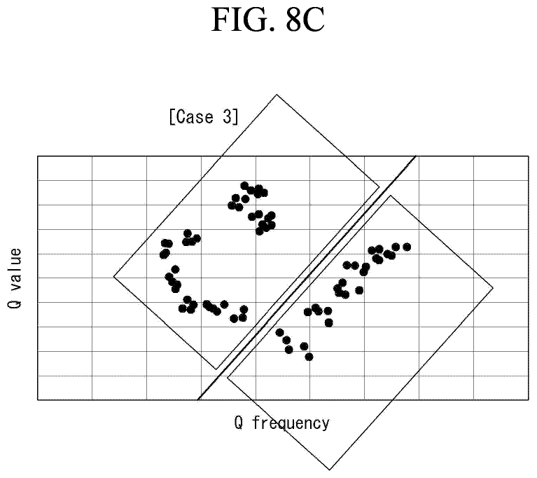

FIGS. 8A to 8C show examples in which the FOD line in the Q plane cannot clearly distinguish between a case in which a foreign object is present and a case in which charging is possible. The FIGS. 8A to 8C show the Q factors measured with a foreign object at various locations, Q factors measured with a receiving device at various locations without foreign objects, and FOD lines stored in the memory on a Q plane.

In the case of the wireless charger of FIG. 8A, the FOD line stored in the memory is located too close to the Q factors measured for the foreign objects on the Q plane, so there is a possibility of incorrectly judging that there is no foreign object for the Q factors of some foreign objects close to the FOD line or beyond the FOD line.

In the case of the wireless charger of FIG. 8B, the FOD line stored in the memory is located too close to the Q factors measured for chargeable receiving devices on the Q plane, so there is a possibility of incorrectly judging that there is a foreign object for some Q factors close to the FOD line or beyond the FOD line.

In the case of the wireless charger of FIG. 8C, the FOD line stored in the memory is separated by a certain distance from the Q factor cluster measured for foreign objects and the Q factor cluster measured for chargeable receiving devices, so it is possible to relatively accurately distinguish between a state in which there is a foreign object and a state in which there is no foreign object and only the receiving device is present based on the stored FOD line and the measured Q factor.

Considering this situation, it is necessary to calibrate the FOD line stored in the memory for each wireless charger.

The receiving device of the previous version, for example Qi 1.2, measures the Q value and transmits it to a transmitting apparatus or a wireless charger in a state of being inductively coupled to the transmitting apparatus or the wireless charger to receive power wirelessly. However, since a coordinate cannot be marked on the Q plane only with the Q value, the transmitting apparatus or the wireless charger cannot calibrate the FOD line using the Q value transmitted by the receiving device.

On the other hand, the receiving device of the latest version, Qi 1.3, can measure not only the Q value but also the Q frequency and transmit them to a inductively coupled wireless charger.

The wireless charger may calibrate the FOD line stored in the memory using the Q value and the Q frequency transmitted by the receiving device.

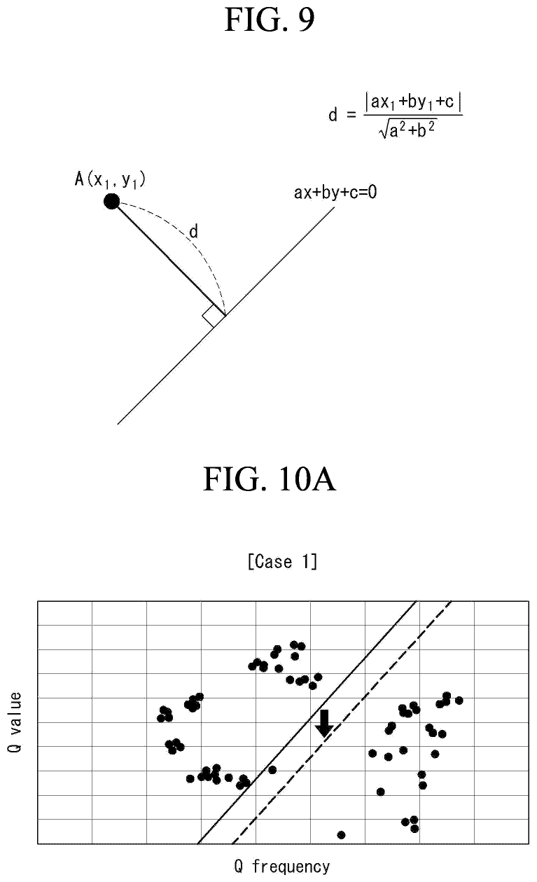

FIG. 9 shows an example of calculating the distance between the FOD line and the coordinates determined by the Q value and Q frequency transmitted from a receiving device in the Q plane.

For example when, in the Q plane where the x-axis is the Q frequency and the y-axis is the Q value, the FOD line stored in the memory is ax+by+c=0 and the coordinate of a point (referred to as a Q point) A corresponding to the Q frequency and Q value transmitted by the receiving device is (x1, y1), a Q distance d between the FOD line and the Q point may be calculated as d=|ax1+by1+c|/(a\hat{ }2+b\hat{ }2)\hat{ }(½).

For a plurality of wireless chargers storing the same FOD line, a Qi 1.3 version receiving device is inductively coupled to receive a Q frequency and a Q value from the receiving device, and the distance between the Q point corresponding to the received Q frequency and Q value and the FOD line may be calculated.

Experimental data obtained by connecting the wireless chargers of FIGS. 8A to 8C to the same Qi 1.3 version receiving device and receiving the Q frequencies and Q values to calculate the distances are as follows.

For the wireless charger in case 1 of FIG. 8A, the received Q frequency and Q value are respectively 82.4 KHz and 34.1 and a distance from the corresponding Q point to the FOD is 96.8.

For the wireless charger in case 2 of FIG. 8B, the received Q frequency and Q value are respectively 86.2 KHz and 27.4 and a distance from the corresponding Q point to the FOD is 23.2.

For the wireless charger in case 3 of FIG. 8C, the received Q frequency and Q value are respectively 84.0 KHz and 28.1 and a distance from the corresponding Q point to the FOD is 43.5.

In the case of the wireless charger in case 3 of FIG. 8C, since the FOD line stored in the memory relatively accurately divides the first area of the Q factor cluster measured in the presence of foreign object and the second chargeable area of the Q factor cluster measured in the absence of the foreign object, 43.5, which is the Q distance between the Q point formed by the Q value and the Q frequency transmitted from the Qi 1.3 version receiving device and the FOD line may be determined as the optimal Q distance.

When the wireless charger is shipped, the optimal Q distance obtained by the method described above may be stored in memory.

After shipment, the wireless charger may receive a Q value and a Q frequency, that is, a Q factor, from a receiving device when connected to a Qi version 1.3 receiving device, calculate a Q distance between the Q point corresponding to the received Q factor and the FOD line stored in a memory in the Q plane, and calibrate the FOD line (precisely the value of the constant c in the FOD line) so that the Q distance between the Q point and the FOD becomes the optimal Q distance stored in the memory.

Thereafter, the wireless charger may measure a Q factor in an inductively coupled state with a receiving device, and determine, by using the calibrated FOD line, whether the measured Q factor belongs to the first area with foreign object or the second area where charging is possible without foreign object in the Q plane, so will be able to more accurately determine whether or not there is a foreign object.

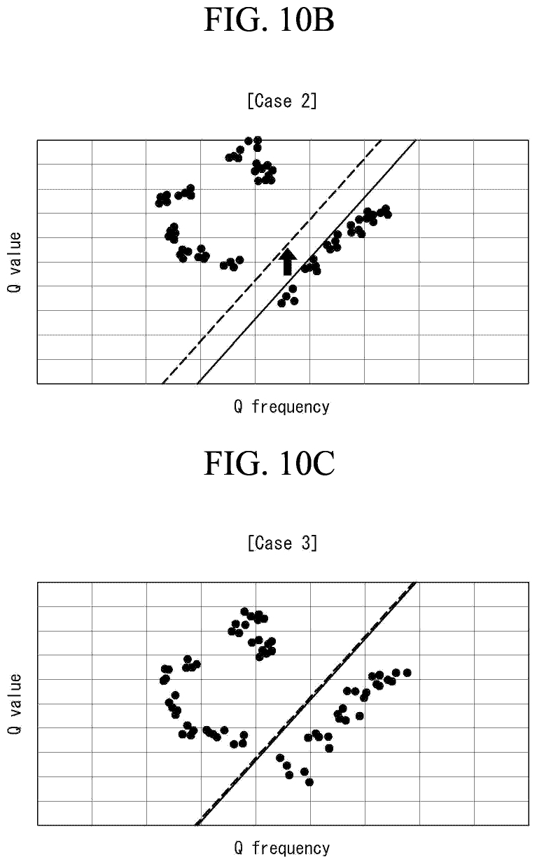

FIGS. 10A to 10C show examples in which the FOD line clearly distinguishes between a case in which a foreign object is present and a case in which charging is possible by adding an offset to the FOD line with a Q value and a Q frequency transmitted from a receiving device

In any one of FIGS. 10A to 10C, the solid line is the FOD line stored in the memory of the wireless charger at the time of shipment, and the dotted line is the FOD line calibrated using the Q factor received after connecting the wireless charger with the Qi 1.3 version receiving device.

The Q factor transmitted by the Qi 1.3 version receiving device (assuming that it is connected without foreign object) is highly likely to be in the chargeable second are.

In case 1 of FIG. 10A, the distance between the FOD line stored in the memory and the second area is long, so if the FOD line stored in the memory is corrected using the Q factor transmitted by the receiving device, it moves in a direction closer to the second area.

In case 2 of FIG. 10B, the distance between the FOD line stored in the memory and the second area is short, so if the FOD line stored in the memory is corrected using the Q factor transmitted by the receiving device, it moves in a direction farther away from the second region.

In case 3 of FIG. 10C, the FOD line stored in the memory is located midway between the first area and the second area, so even if the FOD line stored in the memory is corrected using the Q factor transmitted by the receiving device, the position of the FOD line is hardly changed.

Even if the FOD line stored in the memory when a wireless charger is shipped does not accurately reflect the characteristics of the product, so does not relatively accurately distinguish the first area with foreign object and the second area where charging is possible because there is no foreign object and is biased close to the first area or the second area, if the wireless charger receives the Q value and Q frequency from the receiving device while charging the Qi 1.3 version of the receiving device, the wireless charger may use the Q value and Q frequency to calibrate the FOD line (so that the distance from the Q point to the FOD line becomes the value stored in the memory), and then use the calibrated FOD line to more accurately determine whether or not there is a foreign object.

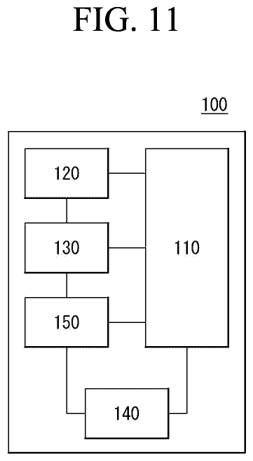

FIG. 11 shows the configuration of a wireless power transmission apparatus to which the embodiment of this disclosure is applied in blocks.

The transmission apparatus of FIG. 11 may further include a Q factor detection unit for detecting a Q factor in addition to the transmission module shown in FIG. 3. Also, the transmission apparatus of FIG. 11 may further include a storage means for storing information related to the FOD line and an output means for notifying the user of attachment of foreign objects. The information related to the FOD line may include FOD line data and a recommended Q distance between the Q point corresponding to the Q factor transmitted by a receiving device and the FOD line.

The wireless power transmitting apparatus 100 or the transmitting module 100 may include a power conversion unit 110, a communication unit 120, a control unit 130, a power supply unit 140, and a Q factor detection unit 150.

The power conversion unit 110 is composed of the inverter and the resonance circuit of FIG. 2, and may be configured to further include a circuit capable of adjusting characteristics such as frequency, voltage, and current used to form a wireless power signal.

The communication unit 120 is connected to the power conversion unit 110 and may detect a power control message by demodulating the wireless power signal modulated by the receiving device that is wirelessly receives power according to inductive coupling. The communication unit 120 of the transmitting module capable of transmitting more than medium power may communicate with a receiving module by including a short-range communication means such as Bluetooth.

The communication unit 120 may receive a message while transmitting power wirelessly to the receiving device of Qi version 1.3 or higher, and extract, form the message, the Q factor of the resonance circuit included in the receiving device, that is, the resonance frequency (Q frequency) and the Q value at that frequency.

The control unit 130 may determine one or more characteristics of an operating frequency, voltage, and current of the power conversion unit 110 based on the message detected by the communication unit 120, and control the power conversion unit 110 to generate a wireless power signal suitable for the message. The communication unit 120 and the control unit 130 may be configured as one module.

The power supply unit 140 may supply power to components of the transmitting module.

The Q factor detection unit 150 may detect the Q factor, that is the resonance frequency and the Q value at the resonance frequency, of the resonance circuit composed of a primary coil and a capacity according to the method described with reference to FIG. 5, while transmitting power to a receiving device. The Q factor detection unit 150 may include a voltage sensor for detecting an input voltage of the resonant circuit and an output voltage applied to the primary coil.

The transmitting module 100 may further include an output unit (not shown) to inform the user that there is a foreign object. The output unit may include at least one of a display unit outputting a message through an image or light, a sound unit transmitting a message through sound, and a vibration unit transmitting a message through vibration.

The control unit 130 for controlling each component of the transmitting module may measure the Q factor of the resonance circuit, that is the resonance frequency (or Q frequency) and the Q value at that frequency, through the Q factor detection unit 150, compare the measured Q factor with the FOD line stored in a memory (not shown) to determine the area the measured Q factor belongs to in a plane formed by a Q frequency and a Q value, that is determine whether the measured Q factor is in a first area with foreign objects or in a second area without foreign objects, determine that there is a foreign object when the Q factor is in the first area, and determine that the receiving device is in a chargeable area without foreign object when the Q factor is in the second area.

If the Q factor measured by the Q factor detection unit 150 is in the second area, the control unit 130 may determine that there is no foreign object and continue charging the receiving device or receiving module.

On the other hand, if the Q factor is in the first area, the control unit 130 may determine that there is a foreign object, and calculate the distance between the Q factor and the FOD line to determine how much the foreign object affects the charging operation. The control unit 130 may determine that the foreign object has a large effect on charging and stop charging if the distance is greater than a predetermined value. Or, if the distance is less than the predetermined value, the controller 130 may determine that the foreign object has little effect on charging, adjust the foreign object determination criterion loosely, and continue the charging operation.

Meanwhile, when the Q factor (Q frequency and Q value) is transmitted from the receiving device (Qi 1.3 version or higher receiving device) through the communication unit 130, the control unit 130 may adjust the FOD line so that the Q distance between and the FOD line and the Q point corresponding to the received Q factor is equal to the Q distance stored in memory and the adjusted FOD line in a memory to use the adjusted FOD line to determine whether there is a foreign object.

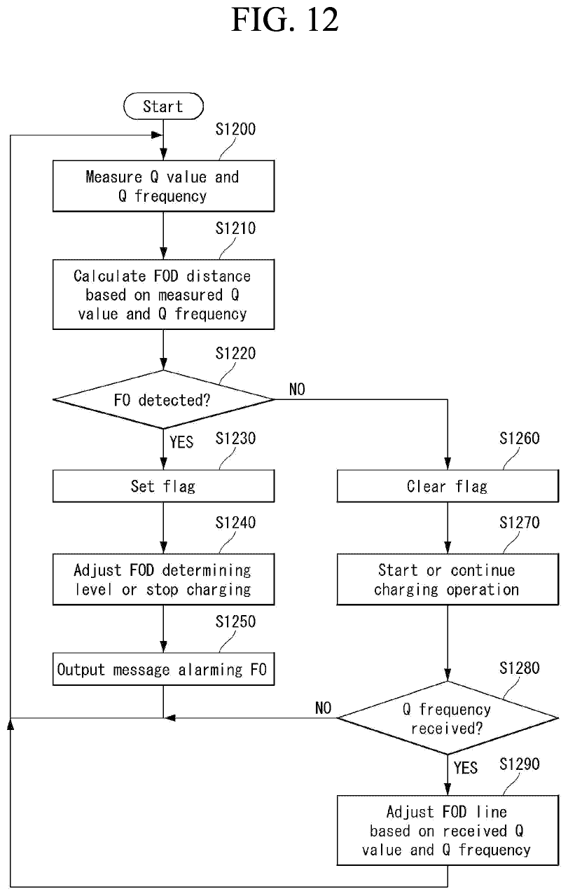

FIG. 12 is a flowchart illustrating an operation of a method for wirelessly transmitting power while detecting a foreign object according to an embodiment of this disclosure. And the operation of FIG. 12 may be performed by the control unit 130 of the transmitting apparatus.

The control unit 130 measures a Q factor, that is a Q frequency and a Q value through the Q factor detection unit 150 (S1200).

The control unit 130 may calculate the Q distance between the Q point corresponding to the measured Q factor and the FOD line stored in a memory (not shown) (S1210).

In addition, the control unit 130 compares the Q point with the FOD line to determine whether the Q point is in the first area with foreign object or in the second area free of foreign object and chargeable (S1220).

If it is confirmed that the Q point is in the first area with foreign object (YES in S1220), the controller 130 sets a flag FLAG value indicating that there is foreign object to 1 (S1230). Step S1210 of calculating the Q distance may be performed after it is confirmed that the Q point is in the first area where there is a foreign object.

If the distance between the Q point corresponding to the Q factor and the FOD line in the Q plane is greater than a predetermined value, the control unit 130 may determine that the foreign object greatly affects charging and stop charging. Or, if the distance is less than or equal to the predetermined value, the controller 130 may determine that the foreign object has little effect on charging, and adjust the foreign object determination criterion loosely to continue the charging operation (S1240).

In addition, the control unit 130 may output an alarm message indicating attachment of foreign object through an output unit (not shown) to notify a user (S1250).

On the other hand, if the controller 130 does not detect a foreign object, that is, if the Q point corresponding to the measured Q factor is compared with the FOD line and it is determined that the Q point is in the second area where there is no foreign object and chargeable (NO in S1220), the control unit 130 resets the value of the flag FLAG of the memory (not shown) to 0 (S1260), and starts a wireless charging operation for the receiving device or continues the charging operation in progress (S1270).

The control unit 130 checks whether the Q factor (Q frequency and Q value) measured by the receiving device is received from the receiving device while the wireless charging operation for the receiving device is in progress (S1280).

When the Q factor is received from the receiving device (YES in S1280), the control unit 130 may calculate the Q distance between the Q point corresponding to the received Q factor and the FOD line stored in the memory, adjust the FOD line so that the calculated Q distance becomes equal to the Q distance stored in the memory, and store the adjusted FOD line in the memory again (S1290).

The FOD line adjusted using the Q factor received from the receiving device is stored in the memory, and then the control unit 130 may use the adjusted FOD line to determine whether or not there is a foreign object in steps S1210 and S1220.

On the other hand, if the Q factor is not received from the receiving device (NO in S1280), the control unit 130 proceeds to step S1200.

The control unit 130 may detect foreign objects by periodically performing the operation of FIG. 12 based on the count value of a timer.

In addition, the control unit 130 may check a flag indicating whether a foreign object is attached, and if there is no foreign object, transmit power until the battery of the receiving device is fully charged.

In this way, the transmitting apparatus may more accurately and efficiently determine whether or not there is a foreign object by more precisely adjusting the criterion for determining whether or not there is a foreign object, for example the FOD line, based on the Q factor transmitted by a receiving device, and may determine whether the charging should be stopped or the charging can be continued even when a foreign object is present based on the distance between the FOD line and the Q point corresponding to the Q factor.

In addition, the transmitting apparatus may prevent excessive heat or fire caused by foreign objects by notifying the existence of foreign objects through images or sounds or stopping power transmission when a foreign object is present. Also, the transmitting apparatus may quickly charge an electronic device by preventing intermittent interruption of the charging operation by foreign objects that do not affect the charging.

The method and apparatus for transmitting power wirelessly in this disclosure may be described as follows.

The method for transmitting power wirelessly according to an embodiment may comprise transmitting power wirelessly to a receiving device, receiving, from the receiving device, a first Q factor including a Q frequency and a Q value measured by the receiving device while transmitting the power, and obtaining a second foreign object boundary line by adjusting a first foreign object boundary line based on a first Q point corresponding to the first Q factor in a Q plane with a Q frequency and a Q value as two axes.

In an embodiment, the method may further comprise detect, as a second Q factor, a Q frequency and a Q value of a resonance circuit included in a transmitting apparatus, and continue or stop a power transmitting operation based on a comparison of a second Q point corresponding to the second Q factor and the second foreign object boundary line in the Q plane.

In an embodiment, the continuing or stopping may comprise check whether in the Q plane the second Q point is in a first area with a foreign object or a second area without the foreign object based on the second foreign object boundary line.

In an embodiment, the first area may be formed in an area where the Q frequency is lower and the Q value is higher based on the boundary line of the second foreign object boundary line in the Q plane, and the second region may be formed in an area where the Q frequency is higher and the Q value is lower based on the second foreign object boundary line in the Q plane.

In an embodiment, the continuing or stopping may further comprise calculate a Q distance between the second Q point and the second foreign object boundary line when the second Q point belongs to the first area, and adjust a foreign object determining criterion based on the Q distance.

In an embodiment, the continuing or stopping may further comprise stop the power transmitting operation when the Q distance is greater than a first value, and continue the power transmitting operation when the Q distance is less than the first value.

In an embodiment, the continuing or stopping may continue the power transmitting operation when the second Q point belongs to the second area.

In an embodiment, the obtaining may change the first foreign object boundary line into the second foreign object boundary line so that a distance from the first foreign object boundary line to the first Q point becomes a first Q distance.

In an embodiment, the first foreign object boundary line and the first Q distance may be stored in a memory of the transmitting apparatus when the transmitting apparatus is shipped.

In an embodiment, the receiving device may have a version of Qi 1.3 or higher.

The wireless power transmitting apparatus according to another embodiment may comprise a power conversion unit including an inverter for converting a DC power into an AC power and a resonance circuit including a primary coil for transmitting power by magnetic induction coupling with a secondary coil of a receiving device, a Q factor detection unit configured to detect a Q frequency and a Q value of the resonance circuit as a Q factor while transmitting the power, a communication unit configured to receive, from the receiving device, a first Q factor including a Q frequency and a Q value measured by the receiving device, and a control unit configured to control the power conversion unit to transmit the power to the receiving device and obtain a second foreign object boundary line by adjusting a first foreign object boundary line based on a first Q point corresponding to the first Q factor received through the communication unit in a Q plane with a Q frequency and a Q value as two axes.

In an embodiment, the control unit may be configured to control the power conversion unit to continue or stop a power transmitting operation based on a comparison of a second Q point corresponding to a second Q factor detected by the Q factor detection unit and the second foreign object boundary line in the Q plane.

In an embodiment, the control unit may be configured to check whether in the Q plane the second Q point is in a first area with a foreign object or a second area without the foreign object based on the second foreign object boundary line, stop the power transmitting operation when the second Q point belongs to the first area and continue the power transmitting operation when the second Q point belongs to the second area.

In an embodiment, the first area may be formed in an area where the Q frequency is lower and the Q value is higher based on the boundary line of the second foreign object boundary line in the Q plane, and the second region may be formed in an area where the Q frequency is higher and the Q value is lower based on the second foreign object boundary line in the Q plane.

In an embodiment, the control unit may be configured to change the first foreign object boundary line into the second foreign object boundary line so that a distance from the first foreign object boundary line to the first Q point becomes a first Q distance.

In an embodiment, the wireless power transmitting apparatus may further comprise a memory configured to store the first foreign object boundary line and the first Q distance when the wireless power transmitting apparatus is shipped.

Throughout the description, it should be understood by those skilled in the art that various changes and modifications are possible without departing from the technical principles of the present invention. Therefore, the technical scope of the present invention is not limited to the detailed descriptions in this specification but should be defined by the scope of the appended claims.

What is claimed is:

1. A method for transmitting power wirelessly, comprising:
transmitting power wirelessly to a receiving device;
receiving, from the receiving device, a first Q factor including a Q frequency and a Q value measured by the receiving device while transmitting the power; and
obtaining a second foreign object boundary line by adjusting a first foreign object boundary line based on a first Q point corresponding to the first Q factor in a Q plane with a Q frequency and a Q value as two axes.

2. The method of claim 1, further comprising:
detecting, as a second Q factor, a Q frequency and a Q value of a resonance circuit included in a transmitting apparatus; and
continuing or stopping a power transmitting operation based on a comparison of a second Q point corresponding to the second Q factor and the second foreign object boundary line in the Q plane.

3. The method of claim 2, wherein the continuing or stopping comprises:
checking whether in the Q plane the second Q point is in a first area with a foreign object or a second area without the foreign object based on the second foreign object boundary line.

4. The method of claim 3, wherein the first area is formed in an area where the Q frequency is lower and the Q value is higher based on the boundary line of the second foreign object boundary line in the Q plane, and the second region is formed in an area where the Q frequency is higher and the Q value is lower based on the second foreign object boundary line in the Q plane.

5. The method of claim 3, wherein the continuing or stopping further comprises:
calculating a Q distance between the second Q point and the second foreign object boundary line when the second Q point belongs to the first area; and
adjusting a foreign object determining criterion based on the Q distance.

6. The method of claim 5, wherein the continuing or stopping stops the power transmitting operation when the Q distance is greater than a first value, and continues the power transmitting operation when the Q distance is less than the first value.

7. The method of claim 3, wherein the continuing or stopping continues the power transmitting operation when the second Q point belongs to the second area.

8. The method of claim 2, wherein the obtaining changes the first foreign object boundary line into the second foreign object boundary line so that a distance from the first foreign object boundary line to the first Q point becomes a first Q distance.

9. The method of claim 8, wherein the first foreign object boundary line and the first Q distance are stored in a memory of the transmitting apparatus when the transmitting apparatus is shipped.

10. The method of claim 1, wherein the receiving device has a version of Qi 1.3 or higher.

11. A wireless power transmitting apparatus, comprising:
a power conversion unit including an inverter for converting a DC power into an AC power and a resonance circuit including a primary coil for transmitting power by magnetic induction coupling with a secondary coil of a receiving device;
a Q factor detection unit configured to detect a Q frequency and a Q value of the resonance circuit as a Q factor while transmitting the power;
a communication unit configured to receive, from the receiving device, a first Q factor including a Q frequency and a Q value measured by the receiving device; and
a control unit configured to control the power conversion unit to transmit the power to the receiving device and obtain a second foreign object boundary line by adjusting a first foreign object boundary line based on a first Q point corresponding to the first Q factor received through the communication unit in a Q plane with a Q frequency and a Q value as two axes.

12. The wireless power transmitting apparatus of claim 11, wherein the control unit is configured to control the power conversion unit to continue or stop a power transmitting operation based on a comparison of a second Q point corresponding to a second Q factor detected by the Q factor detection unit and the second foreign object boundary line in the Q plane.

13. The wireless power transmitting apparatus of claim 12, wherein the control unit is configured to check whether in the Q plane the second Q point is in a first area with a foreign object or a second area without the foreign object based on the second foreign object boundary line, stop the power transmitting operation when the second Q point belongs to the first area and continue the power transmitting operation when the second Q point belongs to the second area.

14. The wireless power transmitting apparatus of claim 13, wherein the first area is formed in an area where the Q frequency is lower and the Q value is higher based on the boundary line of the second foreign object boundary line in the Q plane, and the second region is formed in an area where the Q frequency is higher and the Q value is lower based on the second foreign object boundary line in the Q plane.

15. The wireless power transmitting apparatus of claim 11, wherein the control unit is configured to change the first foreign object boundary line into the second foreign object boundary line so that a distance from the first foreign object boundary line to the first Q point becomes a first Q distance.

16. The wireless power transmitting apparatus of claim 15, further comprising:
a memory configured to store the first foreign object boundary line and the first Q distance when the wireless power transmitting apparatus is shipped.
